(19) United States
(12) Patent Application Publication
(10) Pub. No.: US 2006/0168563 A1
(43) Pub. Date: Jul. 27, 2006

(54) Live shortcuts

(75) Inventors: Michael Muller, Medford, MA (US); Robert J. Stachel, Waltham, MA (US); Suzanne O. Minassian, Boston, MA (US); Andrew L. Schirmer, Andover, MA (US); Charles R. Hill, Belmont, MA (US); Thomas P. Moran, Palo Alto, CA (US)

Correspondence Address: CAREY, RODRIGUEZ, GREENBERG & PAUL, LLP;STEVEN M. GREENBERG, 1300 CORPORATE CENTER WAY, SUITE 105G, WELLINGTON, FL, 33414, US

(73) Assignee: International Business Machines Corporation, Armonk, NY (US)

(21) Appl. No.: 11/040,434

(22) Filed: Jan. 21, 2005

(51) Int. Cl. G06F 9/44

(52) U.S. Cl. 717/120

(57) ABSTRACT

A method, system and apparatus for live creating and managing shortcuts in a computing environment. In a preferred aspect of the present invention, a method for managing live shortcuts can include selecting an underlying object from among one or more underlying objects and creating a live shortcut for the underlying object. The created live shortcut can be positioned in a user interface for a computing environment and liveness can be maintained for the created live shortcut based upon a changing state of the underlying object.

### BACKGROUND OF THE INVENTION

1. Statement of the Technical Field

The present invention relates to liveness, live names and live objects in a computing environment.

2. Description of the Related Art

Liveness is a computing concept which provides substantial advantages in the modem computing environment. Initially implemented in the form of a “live name”, liveness refers to an awareness of status and history for an underlying object. As an example, a live name is a reference within a collaborative environment which indicates the presence of a collaborator associated with name. For example, the live name can indicate whether the collaborator has “logged in” or whether the collaborator has not utilized the collaborator's computer for some time—an idle state. Live names may also provide additional information about the person whose name appears. For example, in an organizational setting, a user may query on a live name in order to see the job title of the named collaborator, or to communicate with the named collaborator. Live names have been most widely utilized in the collaborative chat tool where it can be helpful to know whether a collaborator is available for an online discussion, and to be able to invoke a chat by a simple operation performed upon the collaborator's name.

As an extension of the live name concept, the “live object” in the collaborative computing context can provide similar, advantages. A live object refers to a reference to a document which indicates the current status of the document, for example whether or not the document is in use. The live object also can indicate the identity of a collaborator using the document. In this way, collaborators need not work in isolation towards a common goal. Rather, a team environment can be promoted by the awareness of the presence and activities of fellow collaborators in a collaborative environment.

Notwithstanding the efficacy of a live name or live object, the notion of liveness has not reached its fullest potential. For example, the shortcut, otherwise known as an alias or softlink, refers to a file which consists primarily of a reference to an underlying file and associated meta-data. Accordingly, a short cut is merely a referential object. The principal function of the shortcut is to permit the execution of a referenced application, or the opening of a referenced file utilizing an associated application. For example, in the windowing operating system environment, a shortcut can reference an underlying document or program and, when activated, can cause the activation of the underlying document or program.

It is well-known that shortcuts alone bear no awareness of the underlying state of a referenced object. To wit, if the underlying object ceases to exist, or is moved somewhere else within a file system hierarchy, the shortcut remains blissfully unaware. Any attempt to activate the shortcut subsequent to the removal or relocation of the underlying object can cause a system fault. Of course, to identify the state of specific attributes of an underlying object referenced by a shortcut can require the location of the underlying object prior to any status querying operation. The shortcut in this instance cannot be of help.

### SUMMARY OF THE INVENTION

The present invention addresses the deficiencies of the art in respect to live objects and provides a novel and non-obvious method, system and apparatus for live creating and managing shortcuts in a computing environment. In a preferred aspect of the present invention, a method for managing live shortcuts can include selecting an underlying object from among one or more underlying objects and creating a live shortcut for the underlying object. The created live shortcut can be positioned in a user interface for a computing environment and liveness can be maintained for the created live shortcut based upon a changing state of the underlying object.

Preferably, the creating step can include both writing an entry for the underlying object in a data store of object meta-data, and writing an entry for the created live shortcut in a data store of live shortcut-meta-data. Also, the creating step further can include selecting at least one attribute for the underlying object and writing the selected attribute to the entry for the underlying object in the data store of object meta-data. The maintaining step in turn can include identifying a status for the selected at least one attribute, writing the status to the entry for the underlying object in the data store of object meta-data, reading the status from the entry for the underlying object in the data store of object meta-data, and providing the status through the live shortcut.

In a preferred aspect of the invention, the method can also include creating a new object from the live shortcut and, responsive to the creation of the new object, automatically creating another live shortcut for the new object. The method also can include storing the underlying objects in a repository and limiting access to the underlying objects through the user interface by way of corresponding live shortcuts disposed in the user interface. In this regard, a live shortcut disposed in the user interface can be selected and a new underlying object can be created in the repository based upon an underlying object associated with the selected live shortcut. Subsequently, a new live shortcut can be created for the new underlying object and the new live shortcut can be rendered in the user interface.

A live shortcut can include a shortcut disposed in a user interface and pointing to an underlying object. The live shortcut also can include a data-store of updated status data for the underlying object. Preferably, the live shortcut can include separate data store of meta-data for the shortcut. Finally, the live shortcut can include a view accessible through the shortcut which is configured to present the updated status data. Notably, the underlying object can be disposed in a repository and the underlying object can be configured to be manipulated through the user interface only through the shortcut.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a computing system configured for live shortcuts in accordance with the present invention; and,

FIGS. 2A and 2B, taken together, are a flow chart illustrating a process for creating and managing live shortcuts in the system of FIG. 1.

### DETAILED DESCRIPTION OF THE PREFERRED EMBODIMENTS

The present invention is a method, system and apparatus for creating and managing live shortcuts in a computing environment. In accordance with the present invention, one or more shortcuts can be created based upon an underlying object such as a file or application. Status meta-data can be collected and updated for both the shortcut and the underlying object. Moreover, the status meta-data for the shortcut can include the state of selected attributes for the underlying object. In this way, the state of the underlying object can be accessed through the shortcut without first locating and retrieving the underlying object. Moreover, multiple shortcuts can be maintained for the underlying object which shortcuts can be displayed within the user interface of the computing environment for the convenience of the end user.

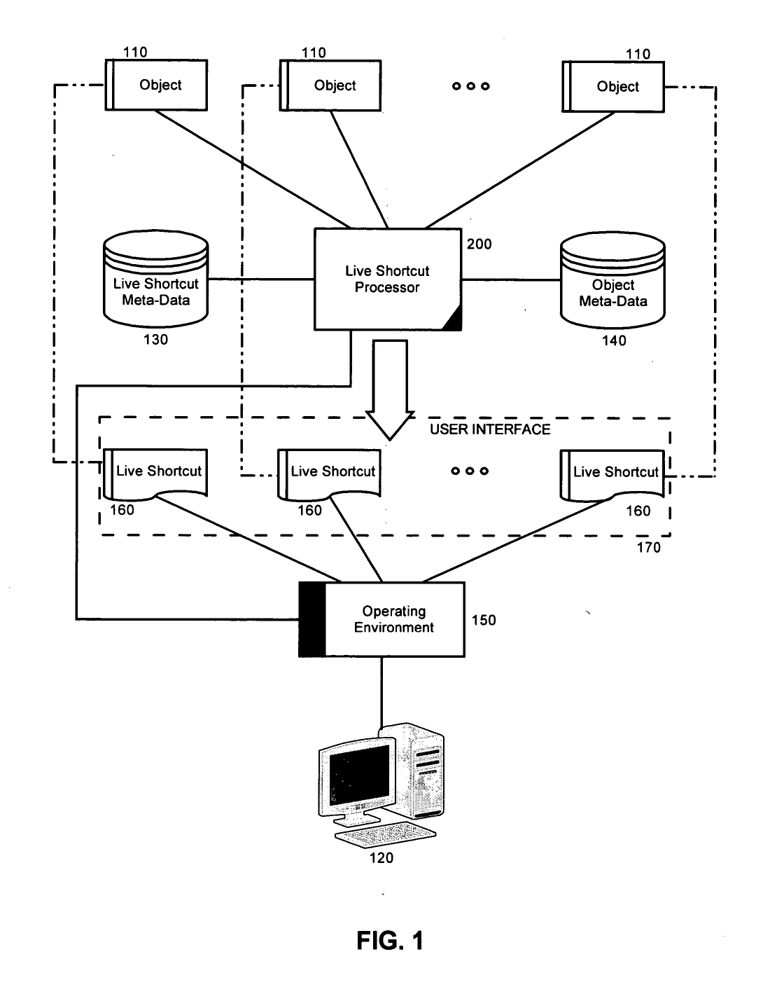

In further illustration of the preferred aspects of the present invention, FIG. 1 is a schematic illustration of a computing system configured for live shortcuts. The system can include an operating environment 150 disposed within a computing platform 120. The operating environment 150 can host and manage the placement of one or more computing objects 110 which computing objects 110 can include files such as document, as well as computing applications and application components, to name a few. Importantly, a live shortcut processor 200 can manage the creation and operation of live shortcuts 160 to the computing objects 110 in the user interface 170 to the operating environment 150.

More specifically, a live shortcut 160 can be created for a computing object 110. The live shortcut 160 can behave as an ordinary shortcut in that the underlying computing object 110 can be executed or opened through the activation of the live shortcut 160. Unlike ordinary shortcuts, however, the live shortcut 160 can include liveness as an inherent characteristic. The liveness can include an awareness not only of the status of the shortcut itself, but also the liveness can include an awareness of one or more selected attributes for the underlying computing object 110. The liveness, in turn, can be presented through the user interface 170 for the benefit of the end user.

Notably, meta-data for the underlying object 110 can be stored in a data store of object meta-data 140. Yet, in a preferred aspect of the invention, the meta-data for the live shortcut itself can be stored separately in a data store of live shortcut meta-data 130. In this way, the live shortcut 160 can be treated by end users as if it were the underlying object 110. However, if the end user desires to access the meta-data for the live shortcut 160 alone, the end user can access the meta-data for the live shortcut 160 in the data store of live shortcut meta-data 130.

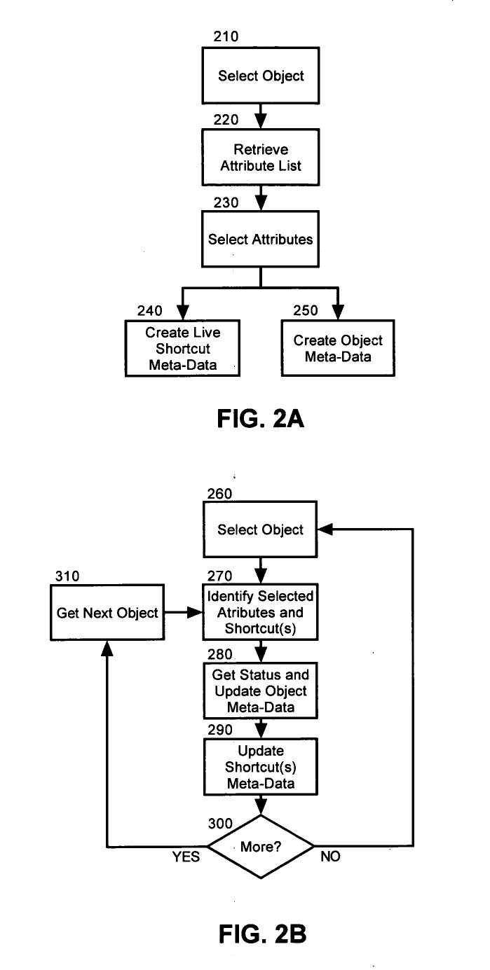

Turning now to FIGS. 2A and 2B, FIGS. 2A and 2B, taken together, are a flow chart illustrating a process for creating and managing live shortcuts in the system of FIG. 1. Beginning first in block 210, an object can be selected based upon which a live shortcut can be created. In block 220, a selection of available attributes for the selected object can be provided and in block 230, one or more of the available attributes can be chosen for liveness. Finally, a live shortcut for the object can be created in that in block 240, an entry can be created in a data store of live shortcut meta-data for the live shortcut, while concurrently, in block 250, an entry can be created in a data store of object meta-data.

The data store of live shortcut meta-data can store meta-data only in respect of the created live shortcut. By comparison, the data store of object meta-data can store the location, identity and state of the selected attributes for the underlying objects. The liveness for the live shortcut can be derived by the periodic updating of the data store of object meta-data for the selected attributes. In contrast, the shortcut specific attributes for the live shortcut can be maintained within the data store of live shortcut meta-data. In this way, multiple live shortcuts can be created for the same underlying object without overly consuming processing resources in maintaining the liveness of the live shortcuts.

Referring again to FIGS. 2A and 2B, once a live shortcut has been created and placed within the user interface of the operating environment, the liveness of the live shortcut can be maintained through a coordinated status update and data store entry writing process. Specifically, in block 260 a first object in the data store of object meta-data can be selected and in block 270, the selected attributes for the selected object can be identified. Additionally, one or more associated live shortcuts for the selected object can be identified. In block 280, the status of the selected attributes for the selected object can be retrieved and the entry to the data store of object meta-data for the selected object can be updated. Finally, in block 290 the status of each related live shortcut can be ascertained and written to corresponding entries in the data store of live shortcut meta-data.

The process of updating the status of both the live shortcut and the underlying object can repeat for each object having a designated one or more live shortcuts. In this regard, in decision block 300 it can be determined if additional objects remain to be processed which have corresponding live shortcuts. If so, in block 310 a next object can be selected for processing in accordance with steps 270 through 300. Otherwise, the process can repeat anew after some appreciable delay for the entirety of the objects having corresponding live shortcuts.

Importantly, in accordance with the present invention, an object can be created not only directly from another object, but also indirectly from a live shortcut to an underlying object. In that circumstance, the object can be created based upon the underlying object referenced by the live shortcut. Additionally, another live shortcut can be created for the newly created object and the meta-data for the new live shortcut can be inherited from the initial live shortcut.

Optionally, the user interface can be limited to the presentation of live shortcuts, while the underlying objects can be hidden from view. Specifically, the underlying objects can be maintained in a repository and are not to be included in a user interface rendering. All representations of the underlying objects are to be limited to corresponding live shortcuts. Wherever new objects are to be created based upon a presented live object, an underlying object can be created in the hidden repository and an additional live shortcut can be created and rendered in the user interface for the newly created object.

Finally, preferably when rendering a live shortcut in the user interface of the operating environment, an end user can create or copy a new object by creating a new, standalone object in the repository with a new live shortcut pointing to the new object, or a new reference can be created for the existing object through the creation of an additional shortcut pointing to the existing object. Consequently, dead links in the live shortcut can be avoided simply because the underlying object can be securely positioned in the repository rather than in a visible portion of the file system which can be manipulated through the user interface.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. In a computing environment, a method for managing live shortcuts comprising the steps of:
selecting an underlying object from among a plurality of underlying objects;
creating a live shortcut for said underlying object;
positioning said created live shortcut in a user interface for the computing environment; and,
maintaining liveness for said created live shortcut based upon a changing state of said underlying object.

2. The method of claim 1, wherein said creating step comprises the steps of:
writing an entry for said underlying object in a data store of object meta-data; and,
writing an entry for said created live shortcut in a data store of live shortcut-meta-data.

3. The method of claim 2, wherein said creating step further comprises the steps of:
selecting at least one attribute for said underlying object; and,
writing said selected at least one attribute to said entry for said underlying object in said data store of object meta-data.

4. The method of claim 3, wherein said maintaining step comprises the steps of:
identifying a status for said selected at least one attribute;
writing said status to said entry for said underlying object in said data store of object meta-data;
reading said status from said entry for said underlying object in said data store of object meta-data; and,
providing said status through said live shortcut.

5. The method of claim 1, further comprising the steps of:
creating a new object from said live shortcut; and,
responsive to said creation of said new object, automatically creating another live shortcut for said new object.

6. The method of claim 1, further comprising the steps of:
storing said plurality of underlying objects in a repository; and,
limiting access to said underlying objects through said user interface by way of corresponding live shortcuts disposed in said user interface.

7. The method of claim 6, further comprising the steps of:
selecting a live shortcut disposed in said user interface;
creating a new underlying object in said repository based upon an underlying object associated with said selected live shortcut;
creating a new live shortcut for said new underlying object; and,
rendering said new live shortcut in said user interface.

8. The method of claim 1, further comprising the step of accessing meta-data regarding said live shortcut separately from meta-data associated with said underlying object.

9. A live shortcut comprising:
a shortcut disposed in a user interface and pointing to an underlying object;
a data-store of updated status data for said underlying object; and,
a view accessible through said shortcut which is configured to present said updated status data.

10. The live shortcut of claim 9, further comprising a separate data store of meta-data for said shortcut.

11. The live shortcut of claim 9, wherein said underlying object is disposed in a repository and wherein said underlying object is configured to be manipulated through said user interface only through said shortcut.

12. A machine readable storage having stored thereon a computer program for managing live shortcuts in a computing environment, the computer program comprising a routine set of instructions which when executed by a machine causes the machine to perform the steps of:
selecting an underlying object from among a plurality of underlying objects;
creating a live shortcut for said underlying object;
positioning said created live shortcut in a user interface for the computing environment; and,
maintaining liveness for said created live shortcut based upon a changing state of said underlying object.

13. The machine readable storage of claim 12, wherein said creating step comprises the steps of:
writing an entry for said underlying object in a data store of object meta-data; and,
writing an entry for said created live shortcut in a data store of live shortcut-meta-data.

14. The machine readable storage of claim 13, wherein said creating step further comprises the steps of:
selecting at least one attribute for said underlying object; and,
writing said selected at least one attribute to said entry for said underlying object in said data store of object meta-data.

15. The machine readable storage of claim 14, wherein said maintaining step comprises the steps of:
identifying a status for said selected at least one attribute;
writing said status to said entry for said underlying object in said data store of object meta-data;
reading said status from said entry for said underlying object in said data store of object meta-data; and,
providing said status through said live shortcut.

16. The machine readable storage of claim 12, further comprising an additional set of instructions which when executed by the machine causes the machine to further perform the steps of:
creating a new object from said live shortcut; and,
responsive to said creation of said new object, automatically creating another live shortcut for said new object.

17. The machine readable storage of claim 12, further comprising an additional set of instructions which when executed by the machine causes the machine to further perform the steps of:
storing said plurality of underlying objects in a repository; and,
limiting access to said underlying objects through said user interface by way of corresponding live shortcuts disposed in said user interface.

18. The machine readable storage of claim 7, further comprising an additional set of instructions which when executed by the machine causes the machine to further perform the steps of:
selecting a live shortcut disposed in said user interface;
creating a new underlying object in said repository based upon an underlying object associated with said selected live shortcut;
creating a new live shortcut for said new underlying object; and,
rendering said new live shortcut in said user interface.

19. The machine readable storage of claim 12, further comprising an additional set of instructions which when executed by the machine causes the machine to further perform the step of accessing meta-data regarding said live shortcut separately from meta-data associated with said underlying object.
